(19) United States
(12) Patent Application Publication
(10) Pub. No.: US 2021/0019932 A1
(43) Pub. Date: Jan. 21, 2021

(54) METHODS AND SYSTEMS FOR SHADING A VOLUME-RENDERED IMAGE

(71) Applicant: GE Precision Healthcare LLC, Milwaukee, WI (US)

(72) Inventor: Lars Hofsoy Breivik, Oslo (NO)

(21) Appl. No.: 16/516,135

(22) Filed: Jul. 18, 2019

(51) Int. Cl. G06T 15/08; G06T 15/50; G06T 15/80

(52) U.S. Cl. CPC G06T 15/08; G06T 15/506; G06T 2200/08; G06T 2200/24; G06T 15/80

(57) ABSTRACT

Various methods and systems are provided for medical imaging. In one embodiment, a method comprises displaying a volume-rendered image from a 3D medical imaging dataset; positioning a first virtual marker within a rendered volume of the volume-rendered image, the rendered volume defined by the 3D medical imaging dataset; and illuminating the rendered volume by projecting simulated light from the first virtual marker. In this way, the illumination of the rendered volume by the first virtual marker visually indicates the position and depth of the first virtual marker within the volume-rendered image.

### FIELD

Embodiments of the subject matter disclosed herein relate to medical imaging.

### BACKGROUND

Some non-invasive medical imaging modalities, such as ultrasound, may acquire 3-dimensional (3D) datasets. The 3D datasets may be visualized with volume-rendered images, which are typically 2D representations of 3D medical imaging datasets. There are currently many different techniques for generating a volume-rendered image. One such technique, ray-casting, includes projecting a number of rays through the 3D medical imaging dataset. Each sample (e.g., voxel) in the 3D medical imaging dataset is mapped to a color and a transparency. Data is accumulated along each of the rays. According to one common technique, the accumulated data along each of the rays is displayed as a pixel in the volume-rendered image. Further, to help aid in visualization of target anatomical features, particularly across different volume-rendered images showing different views of the 3D dataset and/or across different 2D slices of the 3D dataset, a user may position one or more annotations within the 3D dataset, referred to as virtual markers. When images are rendered from the 3D dataset, these virtual markers may be included in the images at the appropriate location(s). However, in some views, it may be difficult to judge the depth of the virtual markers.

### BRIEF DESCRIPTION

In one embodiment, a method includes displaying a volume-rendered image rendered from a 3D medical imaging dataset, positioning a first virtual marker within a rendered volume of the volume-rendered image, the rendered volume defined by the 3D medical imaging dataset, and illuminating the rendered volume by projecting simulated light from the first virtual marker. In this way, the illumination of the rendered volume by the first virtual marker visually indicates the position and depth of the first virtual marker within the volume-rendered image.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present disclosure will be better understood from reading the following description of non-limiting embodiments, with reference to the attached drawings, wherein below:

FIG. 1 shows an example ultrasound imaging system according to an embodiment;

FIG. 2 is a schematic representation of a geometry that may be used to generate a volume-rendered image according to an embodiment;

FIG. 3 is a flow chart illustrating a method for generating a volume-rendered image from a 3D dataset;

FIG. 4 is a schematic representation of an orientation of multiple light sources and a 3D medical imaging dataset according to an embodiment;

FIG. 5 is an example volume-rendered image including three virtual markers; and

FIG. 6 shows the example volume-rendered image with the three virtual markers and with corresponding illumination from simulated light projected from each virtual marker.

### DETAILED DESCRIPTION

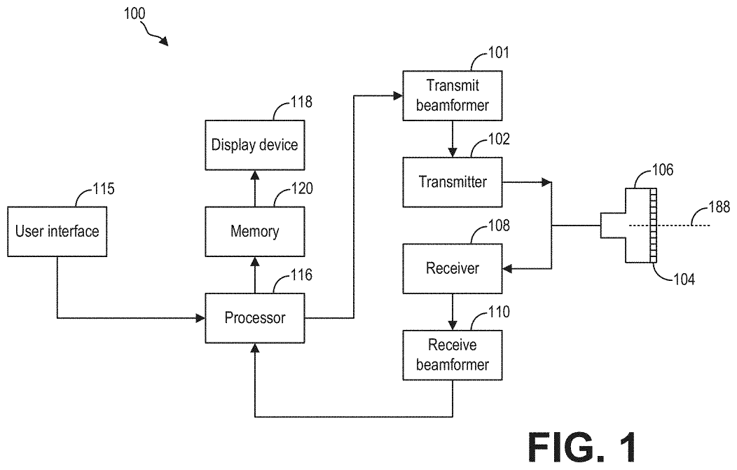

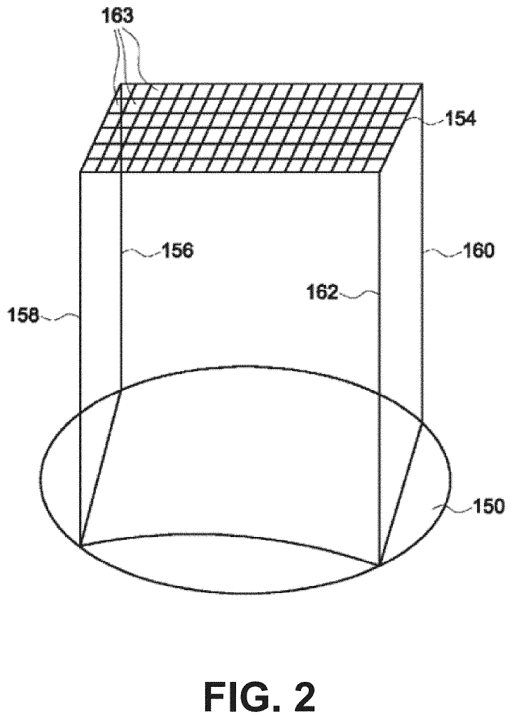

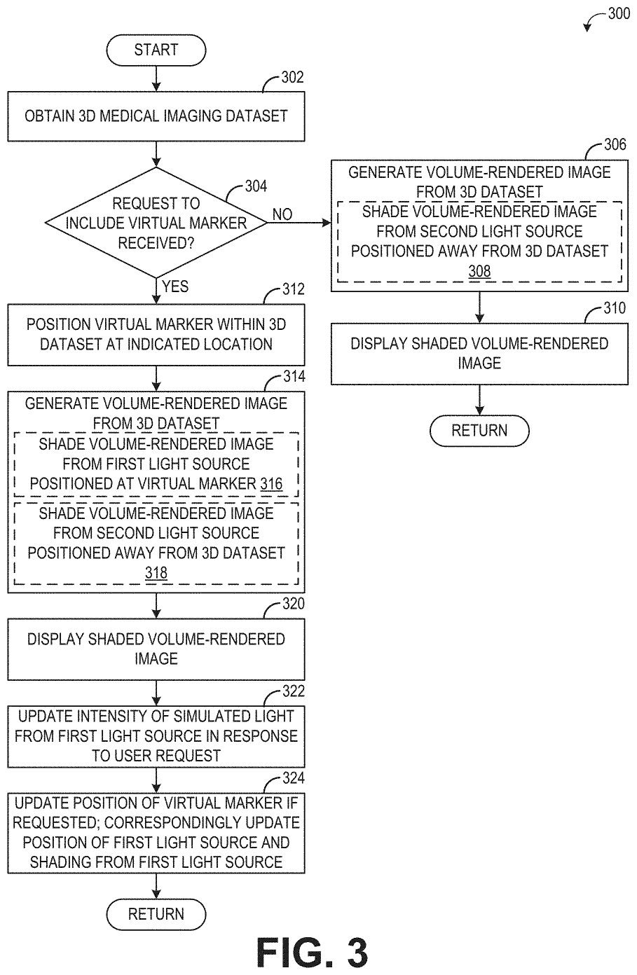

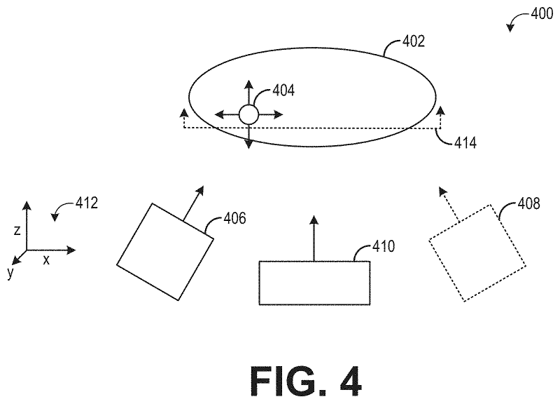

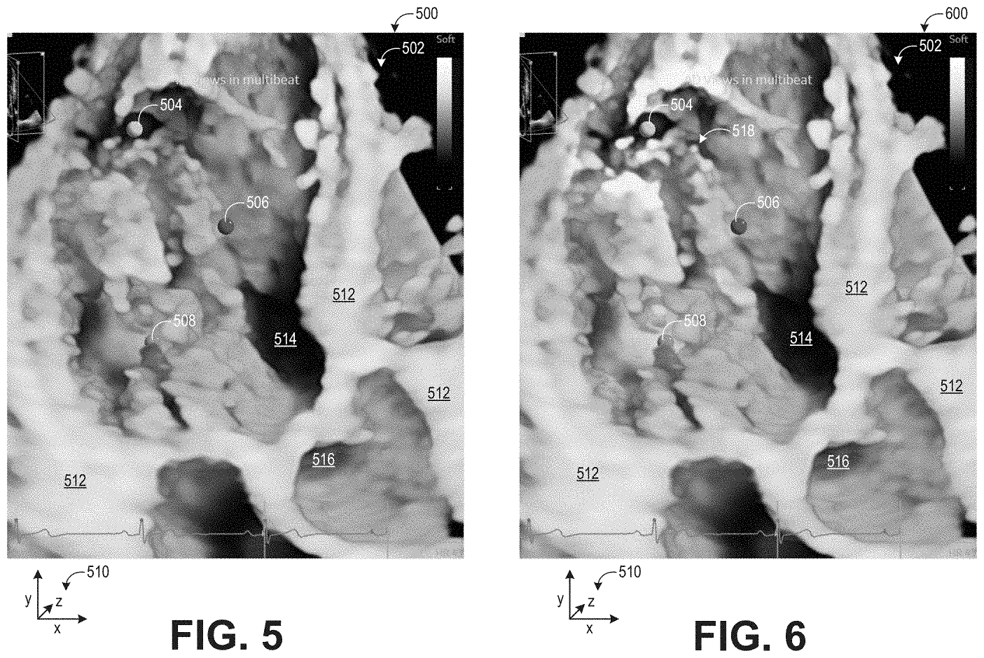

The following description relates to various embodiments for non-invasive volumetric medical imaging, such as volumetric ultrasound imaging, carried out with a medical imaging system, such the ultrasound imaging system of FIG. 1. In particular, the following description relates to shading a volume-rendered image generated from a volumetric dataset acquired from a medical imaging system. The volume-rendered image may be generated according to a suitable technique, as shown in FIG. 2. The volume-rendered image may be shaded with a light source associated with a virtual marker, in order to provide depth cues to enhance the determination of the location of the virtual marker, as shown by the method of FIG. 3. In order to gain an additional sense of depth and perspective, volume-rendered images are oftentimes shaded with one or more external light sources based on a light direction. Shading may be used in order to convey the relative positioning of structures or surfaces in the volume-rendered image. The shading helps a viewer to more easily visualize the three-dimensional shape of the object represented by the volume-rendered image. Virtual markers may be present in volume-rendered images to mark target anatomical features. However, despite the shading from the external light sources, the depth of the virtual markers in the volume-rendered images may be difficult for users of the medical imaging system or other clinicians to judge. Thus, according to embodiments disclosed herein, the virtual markers themselves may act as light sources for the purposes of shading the volume-rendered images. The virtual markers (or light sources associated with the virtual markers) may project simulated light onto the structures around the virtual marker in the volume-rendered images, along with the external light source(s) typically used to provide shading of the volume-rendered images, as shown in FIG. 4. The projected light may have an intensity that drops off as a function of the distance from the light sources and may cast shadows on structures in the volume-rendered images, similar to real light. The virtual markers may be positioned according to user request, at least in some examples, and may be moved according to user request. The light sources associated with the virtual markers may also move, in tandem with the virtual markers, and the shading of the volume-rendered images may be updated as the virtual markers (and hence light sources) move. Further, a user of the medical imaging system (or other end user, such as a clinician viewing the volume-rendered images on an external display device) may adjust the intensity of the light projected from the virtual marker light source(s). When multiple virtual markers are present in the same 3D dataset, each virtual marker may be assigned a different color and the light sources may also project light having the assigned color to improve visual clarity among the virtual markers, as shown in FIGS. 5 and 6. In doing so, the depth of each virtual marker may be more easily and quickly determined by viewers of the volume-rendered images.

FIG. 1 is a schematic diagram of an ultrasound imaging system 100 in accordance with an embodiment. The ultrasound imaging system 100 includes a transmit beamformer 101 and a transmitter 102 that drive elements 104 within a transducer array or an ultrasound probe 106 to emit pulsed ultrasonic signals into a body (not shown). The ultrasound probe 106 may, for instance, comprise a linear array probe, a curvilinear array probe, a sector probe, or any other type of ultrasound probe. The elements 104 of the ultrasound probe 106 may therefore be arranged in a one-dimensional (1D) or 2D array. Still referring to FIG. 1, the ultrasonic signals are back-scattered from structures in the body to produce echoes that return to the elements 104. The echoes are converted into electrical signals, or ultrasound data, by the elements 104 and the electrical signals are received by a receiver 108. The electrical signals representing the received echoes are passed through a receive beamformer 110 that outputs ultrasound data. According to some embodiments, the probe 106 may contain electronic circuitry to do all or part of the transmit beamforming and/or the receive beamforming. For example, all or part of the transmit beamformer 101, the transmitter 102, the receiver 108, and the receive beamformer 110 may be situated within the ultrasound probe 106. The terms “scan” or “scanning” may also be used in this disclosure to refer to acquiring data through the process of transmitting and receiving ultrasonic signals. The term “data” and “ultrasound data” may be used in this disclosure to refer to one or more datasets acquired with an ultrasound imaging system.

A user interface 115 may be used to control operation of the ultrasound imaging system 100, including to control the input of patient data, to change a scanning or display parameter, to select various modes, operations, and parameters, and the like. The user interface 115 may include one or more of a rotary, a mouse, a keyboard, a trackball, hard keys linked to specific actions, soft keys that may be configured to control different functions, a graphical user interface displayed on the display device 118 in embodiments wherein display device 118 comprises a touch-sensitive display device or touch screen, and the like. In some examples, the user interface 115 may include a proximity sensor configured to detect objects or gestures that are within several centimeters of the proximity sensor. The proximity sensor may be located on either the display device 118 or as part of a touch screen. The user interface 115 may include a touch screen positioned in front of the display device 118, for example, or the touch screen may be separate from the display device 118. The user interface 115 may also include one or more physical controls such as buttons, sliders, rotary knobs, keyboards, mice, trackballs, and so on, either alone or in combination with graphical user interface icons displayed on the display device 118. The display device 118 may be configured to display a graphical user interface (GUI) from instructions stored in memory 120. The GUI may include user interface icons to represent commands and instructions. The user interface icons of the GUI are configured so that a user may select commands associated with each specific user interface icon in order to initiate various functions controlled by the GUI. For example, various user interface icons may be used to represent windows, menus, buttons, cursors, scroll bars, and so on. According to embodiments where the user interface 115 includes a touch screen, the touch screen may be configured to interact with the GUI displayed on the display device 118. The touch screen may be a single-touch touch screen that is configured to detect a single contact point at a time or the touch screen may be a multi-touch touch screen that is configured to detect multiple points of contact at a time. For embodiments where the touch screen is a multi-point touch screen, the touch screen may be configured to detect multi-touch gestures involving contact from two or more of a user's fingers at a time. The touch screen may be a resistive touch screen, a capacitive touch screen, or any other type of touch screen that is configured to receive inputs from a stylus or one or more of a user's fingers. According to other embodiments, the touch screen may comprise an optical touch screen that uses technology such as infrared light or other frequencies of light to detect one or more points of contact initiated by a user.

According to various embodiments, the user interface 115 may include an off-the-shelf consumer electronic device such as a smartphone, a tablet, a laptop, and so on. For the purposes of this disclosure, the term “off-the-shelf consumer electronic device” is defined to be an electronic device that was designed and developed for general consumer use and one that was not specifically designed for use in a medical environment. According to some embodiments, the consumer electronic device may be physically separate from the rest of the ultrasound imaging system 100. The consumer electronic device may communicate with the processor 116 through a wireless protocol, such as Wi-Fi, Bluetooth, Wireless Local Area Network (WLAN), near-field communication, and so on. According to an embodiment, the consumer electronic device may communicate with the processor 116 through an open Application Programming Interface (API).

The ultrasound imaging system 100 also includes a processor 116 to control the transmit beamformer 101, the transmitter 102, the receiver 108, and the receive beamformer 110. The processor 116 is configured to receive inputs from the user interface 115. The receive beamformer 110 may comprise either a conventional hardware beamformer or a software beamformer according to various embodiments. If the receive beamformer 110 is a software beamformer, the receive beamformer 110 may comprise one or more of a graphics processing unit (GPU), a microprocessor, a central processing unit (CPU), a digital signal processor (DSP), or any other type of processor capable of performing logical operations. The receive beamformer 110 may be configured to perform conventional beamforming techniques as well as techniques such as retrospective transmit beamforming (RTB). If the receive beamformer 110 is a software beamformer, the processor 116 may be configured to perform some or all of the functions associated with the receive beamformer 110.

The processor 116 is in electronic communication with the ultrasound probe 106. For purposes of this disclosure, the term “electronic communication” may be defined to include both wired and wireless communications. The processor 116 may control the ultrasound probe 106 to acquire data. The processor 116 controls which of the elements 104 are active and the shape of a beam emitted from the ultrasound probe 106. The processor 116 is also in electronic communication with a display device 118, and the processor 116 may process the data into images for display on the display device 118. The processor 116 may include a CPU according to an embodiment. According to other embodiments, the processor 116 may include other electronic components capable of carrying out processing functions, such as a GPU, a microprocessor, a DSP, a field-programmable gate array (FPGA), or any other type of processor capable of performing logical operations. According to other embodiments, the processor 116 may include multiple electronic components capable of carrying out processing functions. For example, the processor 116 may include two or more electronic components selected from a list of electronic components including: a CPU, a DSP, an FPGA, and a GPU. According to another embodiment, the processor 116 may also include a complex demodulator (not shown) that demodulates the RF data and generates raw data. In another embodiment the demodulation can be carried out earlier in the processing chain. The processor 116 is adapted to perform one or more processing operations according to a plurality of selectable ultrasound modalities on the data. The data may be processed in real-time during a scanning session as the echo signals are received. For the purposes of this disclosure, the term “real-time” is defined to include a procedure that is performed without any intentional delay. For example, an embodiment may acquire images at a real-time rate of 7-20 volumes/sec. The ultrasound imaging system 100 may acquire 2D data of one or more planes at a significantly faster rate. However, it should be understood that the real-time volume-rate may be dependent on the length of time that it takes to acquire each volume of data for display. Accordingly, when acquiring a relatively large volume of data, the real-time volume-rate may be slower. Thus, some embodiments may have real-time volume-rates that are considerably faster than 20 volumes/sec while other embodiments may have real-time volume-rates slower than 7 volumes/sec. The data may be stored temporarily in a buffer (not shown) during a scanning session and processed in less than real-time in a live or off-line operation. Some embodiments of the disclosure may include multiple processors (not shown) to handle the processing tasks that are handled by processor 116 according to the exemplary embodiment described hereinabove. It should be appreciated that other embodiments may use a different arrangement of processors.

The ultrasound imaging system 100 may continuously acquire data at a volume-rate of, for example, 10 Hz to 30 Hz. Images generated from the data may be refreshed at a similar frame-rate. Other embodiments may acquire and display data at different rates. For example, some embodiments may acquire data at a volume-rate of less than 10 Hz or greater than 30 Hz depending on the size of the volume and the intended application. The memory 120 is included for storing processed volumes of acquired data. In an exemplary embodiment, the memory 120 is of sufficient capacity to store at least several seconds' worth of volumes of ultrasound data. The volumes of data are stored in a manner to facilitate retrieval thereof according to its order or time of acquisition. The memory 120 may comprise any known data storage medium.

Optionally, embodiments of the present disclosure may be implemented utilizing contrast agents. Contrast imaging generates enhanced images of anatomical structures and blood flow in a body when using ultrasound contrast agents including microbubbles. After acquiring data while using a contrast agent, the image analysis includes separating harmonic and linear components, enhancing the harmonic component and generating an ultrasound image by utilizing the enhanced harmonic component. Separation of harmonic components from the received signals is performed using suitable filters. The use of contrast agents for ultrasound imaging is well-known by those skilled in the art and will therefore not be described in further detail.

In various embodiments of the present disclosure, data may be processed by other or different mode-related modules by the processor 116 (e.g., B-mode, Color Doppler, M-mode, Color M-mode, spectral Doppler, Elastography, TVI, strain, strain rate, and the like) to form 2D or 3D data. For example, one or more modules may generate B-mode, color Doppler, M-mode, color M-mode, spectral Doppler, Elastography, TVI, strain, strain rate, and combinations thereof, and the like. The image lines and/or volumes are stored and timing information indicating a time at which the data was acquired in memory may be recorded. The modules may include, for example, a scan conversion module to perform scan conversion operations to convert the image volumes from beam space coordinates to display space coordinates. A video processor module may be provided that reads the image volumes from a memory and displays an image in real time while a procedure is being carried out on a patient. A video processor module may store the images in an image memory, from which the images are read and displayed.

As mentioned above, the ultrasound probe 106 may comprise a linear probe or a curved array probe. FIG. 1 further depicts a longitudinal axis 188 of the ultrasound probe 106. The longitudinal axis 188 of the ultrasound probe 106 extends through and is parallel to a handle of the ultrasound probe 106. Further, the longitudinal axis 188 of the ultrasound probe 106 is perpendicular to an array face of the elements 104.

Though an ultrasound system is described by way of example, it should be understood that the present techniques may also be useful when applied to images acquired using other imaging modalities, such as magnetic resonance imaging (MRI), CT, tomosynthesis, PET, C-arm angiography, and so forth. For example, a volumetric imaging dataset may be acquired with another suitable modality, such as MRI, and the virtual markers and light sources discussed herein may be applied to the volume-rendered images generated from the volumetric magnetic resonance dataset. The present discussion of an ultrasound imaging modality is provided merely as an example of one suitable imaging modality.

FIG. 2 is a schematic representation of geometry that may be used to generate a volume-rendered image according to an embodiment. FIG. 2 includes a 3D medical imaging dataset 150 and a view plane 154. The 3D medical imaging dataset 150 may be acquired with a suitable imaging modality. For example, the 3D imaging dataset 150 may be acquired with an ultrasound probe of an ultrasound imaging system (e.g., probe 106 of ultrasound imaging system 100 of FIG. 1). For example, the ultrasound probe may scan across a physical, non-virtual volume (e.g., an abdomen or torso of a patient) in order to generate the 3D medical imaging dataset 150, with the 3D medical imaging dataset 150 including data (e.g., voxels) describing the physical, non-virtual volume (e.g., in a configuration corresponding to the configuration of the physical, non-virtual volume). The 3D medical imaging dataset 150 may be stored in memory of a computing device, e.g., memory 120 of FIG. 1. As described below, a volume-rendered image may be generated from the 3D medical imaging dataset via a processor, such as processor 116 of FIG. 1.

Referring to both FIGS. 1 and 2, the processor 116 may generate a volume-rendered image according to a number of different techniques. According to an embodiment, the processor 116 may generate a volume-rendered image through a ray-casting technique from the view plane 154. The processor 116 may cast a plurality of parallel rays from the view plane 154 to or through the 3D medical imaging dataset 150. FIG. 2 shows a first ray 156, a second ray 158, a third ray 160, and a fourth ray 162 bounding the view plane 154. It should be appreciated that additional rays may be cast in order to assign values to all of the pixels 163 within the view plane 154. The 3D medical imaging dataset 150 may comprise voxel data, where each voxel, or volume-element, is assigned a value or intensity. Additionally, each voxel may be assigned an opacity as well. The value or intensity may be mapped to a color according to some embodiments. The processor 116 may use a “front-to-back” or a “back-to-front” technique for volume composition in order to assign a value to each pixel in the view plane 154 that is intersected by the ray. For example, starting at the front, that is the direction from which the image is viewed, the intensities of all the voxels along the corresponding ray may be summed. Then, optionally, the intensity may be multiplied by an opacity corresponding to the opacities of the voxels along the ray to generate an opacity-weighted value. These opacity-weighted values are then accumulated in a front-to-back or in a back-to-front direction along each of the rays. The process of accumulating values is repeated for each of the pixels 163 in the view plane 154 in order to generate a volume-rendered image. According to an embodiment, the pixel values from the view plane 154 may be displayed as the volume-rendered image. The volume-rendering algorithm may additionally be configured to use an opacity function providing a gradual transition from opacities of zero (completely transparent) to 1.0 (completely opaque). The volume-rendering algorithm may account for the opacities of the voxels along each of the rays when assigning a value to each of the pixels 163 in the view plane 154. For example, voxels with opacities close to 1.0 will block most of the contributions from voxels further along the ray, while voxels with opacities closer to zero will allow most of the contributions from voxels further along the ray. Additionally, when visualizing a surface, a thresholding operation may be performed where the opacities of voxels are reassigned based on the values. According to an exemplary thresholding operation, the opacities of voxels with values above the threshold may be set to 1.0 while the opacities of voxels with values below the threshold may be set to zero. Other types of thresholding schemes may also be used. An opacity function may be used to assign opacities other than zero and 1.0 to the voxels with values that are close to the threshold in a transition zone. This transition zone may be used to reduce artifacts that may occur when using a simple binary thresholding algorithm. For example, a linear function mapping opacities to values may be used to assign opacities to voxels with values in the transition zone. Other types of functions that progress from zero to 1.0 may also be used. Volume-rendering techniques other than the ones described above may also be used in order to generate a volume-rendered image from a 3D medical imaging dataset.

The volume-rendered image may be shaded in order to present the user with a better perception of depth. This may be performed in several different ways according to various embodiments. For example, a plurality of surfaces may be defined based on the volume-rendering of the 3D medical imaging dataset. According to an embodiment, a gradient may be calculated at each of the pixels. The processor 116 (shown in FIG. 1) may compute the amount of light at positions corresponding to each of the pixels and apply one or more shading methods based on the gradients and specific light directions. The view direction may correspond with the view direction shown in FIG. 2. The processor 116 may also use multiple light sources as inputs when generating the volume-rendered image. For example, when ray casting, the processor 116 may calculate how much light is reflected, scattered, or transmitted from each voxel in a particular view direction along each ray. This may involve summing contributions from multiple light sources. The processor 116 may calculate the contributions from all the voxels in the volume. The processor 116 may then composite values from all of the voxels, or interpolated values from neighboring voxels, in order to compute the final value of the displayed pixel on the image. While the aforementioned example described an embodiment where the voxel values are integrated along rays, volume-rendered images may also be calculated according to other techniques such as using the highest value along each ray, using an average value along each ray, or using any other volume-rendering technique.

Although the volume-rendered image is a 2D rendering of image data included by the 3D medical imaging dataset 150 as viewed from view plane 154, the volume-rendered image has the appearance of depth (e.g., structures shown in the volume-rendered image may be illuminated differently depending on the distance of voxels in the 3D medical imaging dataset 150 from the view plane 154). The volume-rendered image may be described herein as having rendered volume, where the rendered volume is defined by the voxel data of the 3D medical imaging dataset and refers to the appearance of depth of the volume-rendered image (e.g., as viewed from view plane 154). Examples of rendered volume are described below with reference to FIGS. 5-6.

FIG. 3 is a flow chart illustrating a method 300 for generating a volume-rendered image. Method 300 is described below with regard to the systems and components depicted in FIG. 1, though it should be appreciated that method 300 may be implemented with other systems and components without departing from the scope of the present disclosure. In some embodiments, method 300 may be implemented as executable instructions in any appropriate combination of the ultrasound imaging system 100, an edge device (e.g., an external computing device) connected to the ultrasound imaging system 100, a cloud in communication with the imaging system, and so on. As one example, method 300 may be implemented in non-transitory memory of a computing device, such as the controller (e.g., processor 116 and memory 120) of the ultrasound imaging system 100 in FIG. 1.

At 302, a 3D medical imaging dataset of a 3D volume is obtained. The 3D dataset may be acquired with a suitable imaging modality, such as the ultrasound probe 106 of FIG. 1, and the 3D volume may be a portion or an entirety of an imaging subject, such as a heart of a patient. Accordingly, in some examples, the 3D dataset may be generated from ultrasound data obtained via an ultrasound probe. The 3D medical imaging dataset may include voxel data where each voxel is assigned a value and an opacity. The value and opacity may correspond to the intensity of the voxel.

At 304, method 300 includes determining if a request to include a virtual marker on and/or within the 3D dataset is received. The virtual marker may be included in the 3D dataset in response to a request from a user. For example, a user may select a menu item or control button displayed on a graphical user interface indicating that a virtual marker is to be positioned within the 3D dataset. The virtual marker may indicate an anatomical feature of interest or otherwise mark a region of interest of the imaged 3D volume, and may be displayed in the images acquired with the ultrasound system and displayed on a display device and/or saved for later viewing, as will be described in more detail below. If a request to include a virtual marker is received, method 300 proceeds to 312 to position the virtual marker within the 3D dataset at an indicated location. In some examples, the location may be indicated by a user. For example, the user may indicate the location via movement of a cursor and subsequent mouse, keyboard, or other input indicating that the position of the cursor is the location for the virtual marker, as one example. The virtual marker may be positioned within the 3D dataset while the user is viewing the 3D dataset or a portion of the 3D dataset (e.g., as a volume-rendered image), and the user may move/enter input via the cursor or enter touch input to indicate the desired location within the 3D dataset at which the virtual marker is to be placed. In other examples, the virtual marker may be positioned according to a similar mechanism (e.g., via a mouse-controlled cursor or via touch input) with respect to a displayed 2D slice of the 3D dataset. In still other examples, the user may enter input indicating the virtual marker should be positioned at a target anatomy, and the ultrasound system may automatically determine where to position the virtual marker. When aspects of the 3D dataset are displayed (such as 2D slices or volume-rendered images, as explained below) that include the virtual marker, the virtual marker is displayed at the indicated location. The virtual marker may be associated with one or more voxels of the 3D dataset and/or the virtual marker may be associated with an anatomical feature of the 3D volume, and when the one or more voxels and/or anatomical feature are displayed, the virtual marker may be displayed as an annotation on the displayed image. The virtual marker may take on a suitable visual appearance, such as a filled circle, rectangle, or other shape, letter or word, or other desired appearance.

At 314, a volume-rendered image is generated from the 3D dataset. The volume-rendered image may be generated according to one of the techniques previously described with respect to FIG. 2. The volume-rendered image may be generated in response to a user request, or the volume-rendered image may be generated automatically, e.g., in response to a scanning protocol or workflow dictating that the volume-rendered image be generated. The volume-rendered image may be a two-dimensional image of a desired plane or planes of the 3D volume (e.g., a 2D representation having rendered volume defined by the data of the 3D dataset), or the volume-rendered image may be a two-dimensional image of a surface of the 3D volume, or other suitable volume-rendered image.

As explained previously, the virtual marker may be positioned on a surface of or within the 3D dataset. When volume-rendered images are generated from the 3D dataset, the depth of the virtual marker may be difficult for a user of the ultrasound system (e.g., a clinician) to judge. For example, it may be challenging for the user to determine if the virtual marker is intended to be positioned within a cavity formed by the imaged structures, or if the virtual marker is intended to be positioned on a surface defining the cavity. Thus, as will be explained in more detail below, the virtual marker may be associated with a first light source that is linked to the virtual marker, such that the first light source is positioned at the same position as the virtual marker. The volume-rendered image is illuminated/shaded using the first light source in order to add depth cues to the image and allow a user to more easily determine the position of the virtual marker.

Accordingly, generating the volume-rendered image includes shading the volume rendered image from a first light source positioned at the virtual marker, as indicated at 316. Further, generating the volume-rendered image includes shading the volume-rendered image from a second light source that is positioned away from the 3D dataset, as indicated at 318. The second light source may be one or more external light sources that are not positioned within the 3D dataset. The first light source is linked to the virtual marker, and thus is positioned (in image space) within the 3D dataset. For example, the first light source may be positioned at one or more voxels of the 3D dataset.

As part of the generation of the volume-rendered image, the shading for the volume-rendered image is determined. As described hereinabove with respect to FIG. 2, the shading of the volume-rendered image may include calculating how light from two or more distinct light sources (e.g., the first light source and the second light source) would interact with the structures represented in the volume-rendered image. The algorithm controlling the shading may calculate how the light would reflect, refract, and diffuse based on intensities, opacities, and gradients in the 3D dataset. The intensities, opacities, and gradients in the 3D dataset may correspond with tissues, organs, and structures in the volume-of-interest from which the 3D dataset was acquired. The light from the multiple light sources is used in order to calculate the amount of light along each of the rays used to generate the volume-rendered image. The positions, orientations, and other parameters associated with the multiple lights sources will therefore directly affect the appearance of the volume-rendered image. In addition, the light sources may be used to calculate shading with respect to surfaces represented in the volume-rendered image.

The shading from the first light source and the second light source(s) may be performed as explained above, with light from the first light source and the second light source(s) used to calculate shading and/or used to calculate the amount of light along each of the rays used to generate the volume-rendered image. In some examples, the shading resulting from the first light source may be determined by estimating the normal of each surface of the volume-rendered image and applying a shading model that has diffuse and specular components. An intensity of the simulated light projected by the first light source in the 3D dataset may be a function of distance from the first light source/virtual marker within the 3D dataset (e.g., inversely proportional to a squared distance from the first light source/virtual marker within the 3D dataset). The shading from the first light source may include superimposing one or more shadows each cast by respective structure(s) in the 3D volume onto surface(s) of the 3D volume. In some examples, the shading from the second light source may be determined in a similar way (e.g., using a same shading model) compared to the determination of the shading from the first light source (e.g., the shading resulting from the second light source may be determined by estimating the normal of each surface of the volume rendered image and applying the same shading model used to calculate shading for the first light source, the model having diffuse and specular components). However, light emitted by the first light source is visually distinguishable from light emitted by the second light source due to the location of the first light source within the 3D dataset (e.g., the first light source is positioned within the 3D dataset, whereas the second light source is positioned outside, or exterior to, the 3D dataset). As one example, light emitted by the first light source may have a different color relative to light emitted by the second light source. As another example, light emitted by the first light source may have an increased apparent intensity and/or brightness due to the location of the first light source within the 3D dataset (e.g., light emitted by the first light source may appear brighter and/or more intense than light emitted by the second light source during conditions in which the first light source and second light source have the same light intensity, due to the first light source being positioned within the 3D dataset and the second light source being positioned outside of the 3D dataset). The location of the first light source within the 3D dataset may result in the first light source being positioned closer to structures described by the 3D dataset (e.g., characterized by the voxels of the 3D dataset), and because the first light source is positioned closer to the structures, the structures may be illuminated by the first light source by a greater amount relative to an amount of illumination of the structures by the second light source.

In some examples, contributions from the first light source and second light source (e.g., light emitted by the first light source and second light source) may be summed in order to determine an amount of lighting of portions of the volume-rendered image. For example, a surface of the volume-rendered image receiving light from each of the first light source and second light source may be rendered with an increased brightness relative to conditions in which the same surface receives light only from the second light source. In some examples, the second light source may emit white light, and the first light source may emit a different color of light (e.g., red light). Surfaces receiving light from each of the first light source and second light source may be illuminated according to a combination of white light from the second light source and colored light from the first light source (e.g., surfaces illuminated by both the first light source and second light source may appear tinted to the color of the first light source, with an amount of saturation of the color being a function of distance of the first light source).

In some examples, the illumination due to the first light source and/or second light source may be a determined using a Phong illumination model modulated by occlusion to account for shadowing. In this example, determining the illumination of a voxel during ray-casting may include summing diffuse and specular contributions modulated by occlusion for the first and/or second light source. In some examples, the occlusion value may be determined by tracing shadow rays from each light source to each voxel to determine the degree of occlusion.

As explained above with respect to FIG. 2, the volume-rendered image may be shaded from the second light source and, in some examples, one or more additional light sources positioned away from the 3D dataset in imaging space, in order to provide illumination and/or shadows on the volume-rendered image that assist in differentiating and recognizing structures in the volume-rendered image, provide depth cues, and mimic how the imaged structures would appear if viewed using visible light. The second light source(s) may be positioned according to the examples provided above with respect to FIG. 2 (e.g., a key light, a fill light, and/or a back light), or other suitable configuration. The second light source(s) may be fixed in place, or the positions, angles, light characteristics, etc., may be adjustable by a user or by the ultrasound system. The second light source(s) may be spaced away from the 3D dataset by a suitable distance(s), which may be in the range of millimeters, centimeters, or meters, or spaced away from the 3D dataset by a suitable number of voxels. The 3D dataset may be comprised of a plurality of voxels and defined by a border, and the second light source(s) may be positioned outside the border of the 3D dataset. In this way, the second light source(s) may provide surface shading for the volume-rendered image.

At 320, the shaded volume-rendered image is displayed on a display device associated with the ultrasound system, such as display device 118. The shaded volume-rendered image may additionally or alternatively be stored in memory, such as memory 120 and/or as part of the imaged subject's electronic medical record, for later viewing. The displayed volume-rendered image includes a visual depiction of the virtual marker (e.g., as explained above) at the indicated location and the structures around the virtual marker in the volume-rendered image are illuminated with simulated light projected from the first light source. Further, the surfaces of the structures depicted in the volume-rendered image are illuminated with simulated light projected from the one or more second light sources.

At 322, the intensity of the simulated light projected from the first light source may be updated in response to a user request. For example, the user may enter suitable input (e.g., to a menu or control button displayed on the display device) requesting the intensity of light projected from the first light source be adjusted (e.g., increased or decreased). When the intensity of the light is adjusted, the shading of the illuminated structures around the virtual marker is also adjusted and hence an adjusted volume-rendered image with adjusted shading may be displayed. In some examples, the user may request that no light be projected from the first light source, and thus the volume-rendered image may only include shading from the second light source(s) in such examples. At 324, the position of the virtual marker is updated if requested, and the position of the first light source, and hence shading of the volume-rendered image, are correspondingly updated as the position of the virtual marker changes. For example, the user may enter input indicating the virtual marker should be repositioned. When the position of the virtual marker changes, the position of the first light source also changes, as the first light source is linked to the virtual marker. When the position of the first light source changes, the illumination/shading of the structures in the volume-rendered image also changes, and thus the shading may be adjusted in the volume-rendered image, or an updated volume-rendered image may be displayed with updated shading. Method 300 then returns.

Returning to 304, if a request to position a virtual marker on or within the 3D dataset is not received, method 300 proceeds to 306 to generate a volume-rendered image without virtual markers from the 3D dataset. The volume-rendered image may be generated as described above with respect to FIG. 2, e.g., using ray casting to generate an image from a designated view plane. Generating the volume-rendered image without the virtual markers may include shading the volume-rendered image from the second light source(s) positioned away from the 3D volume and not shading the volume-rendered image with any light sources associated with any virtual markers.

At 310, the shaded volume-rendered image is displayed on a display device associated with the ultrasound system, such as display device 118. The shaded volume-rendered image may additionally or alternatively be stored in memory, such as memory 120 and/or as part of the imaged subject's electronic medical record, for later viewing. The shaded volume-rendered image that is generated and displayed when there are no virtual markers present does not include a virtual marker or a light source associated with the virtual marker. Method 300 then returns.

FIG. 4 is a schematic representation of an orientation 400 of a 3D dataset 402 and multiple light sources that may be used to apply shading to a volume-rendered image of the 3D dataset 402 in accordance with an embodiment. FIG. 4 is an overhead view and it should be appreciated that other embodiments may use either fewer light sources or more light sources, and/or the light sources may be orientated differently with respect to the 3D dataset 402. The orientation 400 includes a first light source 404, a second light source 406, and an optional third light source 408. The first light source 404, the second light source 406, and optionally the third light source 408 may be used to calculate shading for the volume-rendered image. However, as described previously, the light sources may also be used during a ray-casting process while generating the volume-rendering. The orientation 400 also includes a view direction 410 that represents the position from which the 3D dataset 402 is viewed.

FIG. 4 represents an overhead view and it should be appreciated that each of the light sources may be positioned at a different height with respect to the 3D dataset 402 and the view direction 410.

The first light source 404 is a virtual marker light source that is positioned at a location that corresponds to (e.g., is the same as) the location of a virtual marker placed by a user of the ultrasound system. In the example shown in FIG. 4, the first light source 404 is a point light that projects light in all directions, but other configurations are possible, such as the first light source 404 being a spot light. In examples where the first light source 404 is not a point light, the directionality of the light projected from the first light source may be adjusted by a user. The first light source 404 is positioned at a location that overlaps the 3D dataset. For example, the first light source 404 may be positioned at one or more voxels of the 3D dataset.

The second light source 406 may be positioned at a location that is spaced apart from the 3D dataset 402. For example, as shown, the second light source 406 may be positioned to illuminate a front surface of the 3D dataset 402, and thus may be placed away from the front surface (with respect to the view direction) of the 3D dataset. The second light source 406 may be a suitable light source, such as a key light (e.g., which may be the strongest light source used to illuminate the volume rendering). The second light source 406 may illuminate the volume-rendered image from either the left side or the right side from the reference of the view direction 410. When included, the third light source 408 may be a fill light positioned on an opposite side of the volume rendering as the key light with respect to the view direction 410 in order to reduce the harshness of the shadows from the key light.

The light sources shown in FIG. 4 are exemplary, and other configurations are possible. For example, a fourth light source may be present, where the fourth light source is positioned behind the 3D dataset 402 to act as a back light. The back light may be used to help highlight and separate volume imaged in the 3D dataset 402 from the background. Further, the second light source 406 and third light source 408 (when included) may be positioned in other suitable locations and/or have other suitable intensities, light shapes, etc.

FIG. 4 includes a coordinate system 412. As shown, the 3D dataset extends along the x and z axes (and the y axis, though the extent of the dataset along the y axis is not visible in FIG. 4). An example view plane 414 is also shown in FIG. 4. The view plane 414 may extend along the x and y axes and may be the view plane from which the volume-rendered image is rendered. For example, when generating a volume-rendered image with respect to the view plane 414, all data in the 3D dataset in front of the view plane 414 (with respect to the z axis) may be discarded, and the volume-rendered image may be generated such that the view plane 414 acts as the front surface of the volume-rendered image.

FIG. 5 shows an example volume-rendered image 500 generated from a 3D dataset of medical imaging data acquired with an imaging system, such as ultrasound imaging system 100 of FIG. 1. The volume-rendered image 500 may be generated from 3D dataset 402 along view plane 414, at least in some examples. The volume-rendered image 500 depicts structures of a heart 502, e.g., the imaged volume is a heart. A section of internal tissue structures 512 at the view plane are shown, as well as surfaces of the heart behind the view plane not obstructed by the tissue in the view plane, such as cavity 514 and cavity 516. The structures shown by the volume-rendered image 500 form the rendered volume of the volume-rendered image 500. For example, internal tissue structures 512 are shown at a different depth relative to the view plane compared to cavity 514 and cavity 516. The difference in depth of the various structures relative to the view plane provides the three-dimensional appearance, or rendered volume, of the 2D volume-rendered image 500. A coordinate system 510 is shown in FIG. 5, with the view plane extending along the x- and y-axes. The surfaces behind the view plane are behind the view plane along the z-axis.

The volume-rendered image is illuminated with one or more external light sources, such as the second and/or third light sources of FIG. 4. Accordingly, the internal tissue structures 512 at the front of the volume-rendered image (e.g., along the view plane) have a relatively large amount of illumination, while structures further away (e.g., the back surfaces of the chambers shown in FIG. 5) have little or no illumination, as appreciated by cavity 514. Further, shadows are cast by structures between the external light source(s) and surfaces positioned behind the view plane along the z-axis. For example, shadows are cast into cavity 516.

Image 500 includes three virtual markers, a first virtual marker 504, a second virtual marker 506, and a third virtual marker 508. As explained above with respect to FIG. 3, each virtual marker may be positioned according to user input, in order to mark target anatomical structures. Each virtual marker is depicted in a different color, e.g., first virtual marker 504 is shown in yellow, second virtual marker 506 is shown in red, and third virtual marker 508 is shown in green, in order to enhance visualization and differentiation of the virtual markers.

As appreciated by FIG. 5, the position of the virtual markers along the z-axis (e.g., along the depth of the 3D volume) may be difficult to judge in the volume-rendered image 500. As an example, it may be difficult to determine whether the first virtual marker 504 is intended to be positioned along a back surface of the cavity behind the first virtual marker 504 (e.g., at a first distance from the x-y view plane along the positive z direction), or if the first virtual marker 504 is intended to be positioned closer to the view plane (e.g., at a second, shorter distance from the x-y view plane along the positive z direction).

Thus, according to embodiments disclosed herein, each virtual marker may be associated with/linked to a respective light source, and each light source may be used to illuminate structures around the respective virtual marker to provide depth cues for assisting a user in judging the depth of each virtual marker (e.g., to illuminate the structures forming the rendered volume of the volume-rendered image 500). FIG. 6 shows a second volume-rendered image 600 illustrating the heart 502, similar to volume-rendered image 500. In the second volume-rendered image 600, each virtual marker includes a light source projecting simulated light to illuminate the structures around each virtual marker. For example, the first virtual marker 504 may be associated with a first virtual marker light source, the second virtual marker 506 may be associated with a second virtual marker light source, and the third virtual marker 508 may be associated with a third virtual marker light source. Each virtual marker light source may project a different color of simulated light, such that the first virtual marker light source projects yellow light, the second virtual marker light source projects red light, and the third virtual marker light source projects green light.

By including the virtual marker light sources, the depth of each virtual marker may be more easily determined by a user of the ultrasound system. As appreciated by FIG. 6, the first virtual marker 504 is positioned relatively closer to the view plane than the back surfaces of the cavity over which the first virtual marker 504 is placed. Likewise, the second virtual marker 506 is positioned closer to the view plane than the surfaces behind the second virtual marker 506.

When multiple virtual markers are positioned in a 3D dataset, the light sources associated with each virtual marker may project light to one or more of the same voxels. For example, the first virtual marker light source associated with the first virtual marker 504 may project light to a region 518 of the imaged volume, and the second virtual marker light source associated with the second virtual marker 506 may also project light to the region 518. The contributions from both light sources may be summed and used to illuminate/shade the voxels of the region 518. In other examples, a cone or other simulated structure may be placed around each virtual marker light source to restrict the projection of each light source to a threshold range around the respective associated virtual marker, which may reduce overlap of illumination from the virtual marker light sources. Further, in examples where a volume-rendered image includes a virtual marker that is obstructed (in the view of the volume-rendered image) by tissue or other anatomical structures, the virtual marker light source may appear to glow in order to signal to a viewer that a virtual marker is positioned within the imaged tissue, though not visible. In other examples, when the volume-rendered image includes a virtual marker that is obstructed, no light projected from the virtual marker light source may be displayed.

The technical effect of associating a light source with a virtual marker positioned within a volumetric medical imaging dataset and shading a volume-rendered image (rendered from the volumetric medical imaging dataset) according to simulated light projected from the light source is to increase a viewer's depth perception of the virtual marker.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method, comprising:
displaying a volume-rendered image rendered from a 3D medical imaging dataset;
positioning a first virtual marker within a rendered volume of the volume-rendered image in order to mark one of a target anatomical feature and a region of interest, wherein the rendered volume is defined by the 3D medical imaging dataset, wherein the first virtual marker functions as a first light source;
positioning a second light source outside of the volume-rendered image; and
illuminating the rendered volume by projecting first simulated light from the first virtual marker and second simulated light from the second light source, wherein said illuminating the rendered volume comprises combining first contributions from the first virtual marker with second contributions from the second light source in order to provide depth cues for a position of the first virtual marker within the rendered volume.

2. The method of claim 1, wherein illuminating the rendered volume by projecting the first simulated light from the first virtual marker and the second simulated light from the second light source includes superimposing a shadow cast by a first structure within the rendered volume onto a surface of a second structure within the rendered volume.

3. (canceled)

4. The method of claim 1, further comprising positioning a second virtual marker within the rendered volume, and wherein illuminating the rendered volume includes projecting third simulated light from the second virtual marker.

5. The method of claim 1, wherein the first simulated light is a first color and the second simulated light is a second color that is different than the first color, and wherein said illuminating the rendered volume comprises illuminating one or more surfaces in the rendered volume according to a combination of both the first simulated light and the second simulated light.

6. The method of claim 1, wherein the first virtual marker projects the first simulated light in a spherical fashion, in order to illuminate the rendered volume in all directions from the first virtual marker.

7. The method of claim 1, wherein positioning the first virtual marker comprises positioning the first virtual marker in response to user input.

8. The method of claim 1, further comprising acquiring the 3D medical imaging dataset via an ultrasound probe, the 3D medical imaging dataset comprising a plurality of voxels and associated intensity and/or opacity values representing a physical, non-virtual volume scanned by the ultrasound probe.

9. The method of claim 8, wherein illuminating the rendered volume comprises applying the combined first contributions and second contributions to each voxel of the plurality of voxels.

10. (canceled)

11. The method of claim 1, further comprising receiving user input requesting to display the first virtual marker at the first location, and in response, positioning the virtual marker at the first location in the 3D dataset.

12. (canceled)

13. (canceled)

14. The method of claim 1, further comprising shading the volume-rendered image based on the combination of the first contributions from the first virtual marker with the second contributions from the second light source, and wherein generating the volume-rendered image comprises generating the volume-rendered image from a plurality of voxels of the 3D dataset using ray-casting.

15. (canceled)

16. A system, comprising:
an ultrasound probe;
a display; and
a processor configured with instructions stored in non-transitory memory that, when executed, cause the processor to:
generate a volume-rendered image from a 3D dataset acquired with the ultrasound probe, the volume-rendered image including a virtual marker positioned at a first location within the volume-rendered image in order to mark one of a target anatomical feature and a region of interest;
illuminate and shade the volume-rendered image by projecting first simulated light from a first light source positioned at the first location and second simulated light from the second light source at a second location outside of the volume-rendered image and combining first contributions from the first light source with second contributions from the second light source in order to provide depth cues for a position of the virtual marker within the rendered volume; and
display the illuminated and shaded volume-rendered image on the display.

17. The system of claim 16, wherein the first light source has a first light intensity and the second light source has a different, second light intensity.

18. The system of claim 16, further comprising instructions stored in the non-transitory memory that, when executed, cause the processor to:
adjust the position of the first light source from the first location to a third location responsive to user input requesting adjustment of the virtual marker from the first location to the third location.

19. The system of claim 16, wherein the volume-rendered image is a first volume-rendered image having a first view plane; and
further comprising instructions stored in the non-transitory memory that, when executed, cause the processor to:
generate a second volume-rendered image from the 3D dataset acquired with the ultrasound probe, the second volume-rendered image including the virtual marker maintained at the first location of the 3D dataset, the second volume-rendered image having a different, second view plane;
illuminate and shade the second volume-rendered image from the first light source positioned at the first location and the second light source positioned at the second location; and
display the illuminated and shaded second volume-rendered image on the display.

20. The system of claim 16, further comprising instructions stored in the non-transitory memory that, when executed, cause the processor to:
adjust an intensity or color of the first light source responsive to user input; and
update the illuminated and shaded volume-rendered image on the display based on the adjusted intensity or color of the first light source.

21. The method of claim 1, further comprising receiving user input identifying the target anatomical feature, in response, automatically positioning the first virtual marker at the first location corresponding to the target anatomical feature in the rendered volume.

22. The method of claim 1, wherein the first simulated light is a first intensity and the second simulated light is a second intensity that is different than the first intensity, and wherein said illuminating the rendered volume comprises illuminating one or more surfaces in the rendered volume according to a combination of both the first simulated light and the second simulated light received at the one or more surfaces.

23. The method of claim 1, wherein the depth cues include a surface shading for the volume-rendered image.

24. The method of claim 1, further comprising displaying an annotation associated with the first virtual marker.

25. The system of claim 16, further comprising instructions stored in the non-transitory memory that, when executed, cause the processor to automatically position the first virtual marker at the first location corresponding to the target anatomical feature in the rendered volume in response to receiving a user input identifying the target anatomical feature.
